(19) United States
(12) Patent Application Publication
(10) Pub. No.: US 2020/0057871 A1
(43) Pub. Date: Feb. 20, 2020

(54) APPARATUSES AND METHODS FOR SIGNING A LEGAL DOCUMENT

(71) Applicant: Robin P. Hartley, Surrey (GB)

(72) Inventor: Robin P. Hartley, Surrey (GB)

(21) Appl. No.: 16/346,457

(22) PCT Filed: Oct. 31, 2017
(86) PCT No.: PCT/GB2017/053273

§ 371 Date: Apr. 30, 2019

(30) Foreign Application Priority Data
Oct. 31, 2016 (GB) 1618387.3

(51) Int. Cl. G06F 21/64; H04L 9/32; G06F 17/27; H04L 9/06

(52) U.S. Cl. CPC G06F 21/645; H04L 9/3247; H04L 2209/64; H04L 9/0643; G06F 17/277

(57) ABSTRACT

Provided is a server, for use in digitally signing writing in a legal document, wherein a signee has an associated public/private key pair, the server comprising: one or more processors; a communication module, to communicate with a signee device; memory comprising instructions which when executed by one or more of the processors configure the server to: process a document based on a set of rules to extract writing from the document, for signing, from other document data; and generate, on the server, or receive, from the signee device: a hash of the extracted writing; a signee security stamp based on a private key associated with the signee and the hash.

### BACKGROUND

Despite the potential convenience of electronic signatures, they are not widely used in commerce or legal practice other than for low-risk or low-value documents. This is due to fundamental deficiencies in existing electronic signing processes, which fail to: mitigate the potential for mistakes and abuse, and consequently fail to meet the relevant legal thresholds for the enforcement of many types of contract; and conform to common practices in transactions (many of which have been enshrined in legislation and tax rules) meaning lawyers are reluctant or unable to adopt electronic signatures as part of their workflow.

### BRIEF SUMMARY OF THE DISCLOSURE

The application discloses, in embodiments, a server, for use in digitally signing writing in a legal document, wherein a signee has an associated public/private key pair, the server comprising: one or more processors; a communication module, to communicate with a signee device; memory comprising instructions which when executed by one or more of the processors configure the server to: process a document based on a set of rules to extract writing from the document, for signing, from other document data; and generate, on the server, or receive, from the signee device: a hash of the extracted writing; a signee security stamp based on a private key associated with the signee and the hash. In embodiments the instructions further configure the server to update the document to include the signee security stamp. In embodiments the instructions further configure the server to generate, on the server, or receive, from the signee device, a randomness metric indicative of randomness of the writing. In embodiments the instructions further configure the server to: calculate the proportion of the extracted writing which is in a lexicon; and generate the randomness metric by comparing the proportion of the extracted writing which is in the lexicon with the entire writing. In embodiments the proportion of the extracted writing is calculated by the number of: bits, bytes, characters, words, paragraphs, or combinations thereof. In embodiments the instructions further configure the server to update the document to including the randomness metric. In embodiments the instructions further configure the server to update the document to include the hash value. In embodiments the instructions further configure the server to authenticate credentials of the signee. In embodiments the instructions further configure the server to further authenticate the signee by a second level of authentication. In embodiments, the instructions further configure the server to create a session with session variables uniquely linked to the web browser used by the signee. In embodiments, the instructions further configure the server to verify that the signee's web browser is being operated by an individual with access to information (such as passwords) and/or hardware (such as a phone, e.g. by receipt of an SMS message) which should only be in the possession of the signee. In embodiments the instructions further configure the server to receive the unsigned document from the signee device. In embodiments the instructions further configure the server to transmit the updated document to the signee device. In embodiments the communication module is further configured to communicate with a witness device. In embodiments the instructions further configure the server to, generate on the server, or receive, from the signee device or the witness device, a witness security stamp, associated with a witness of the signee signing the document. In embodiments the instructions further configure the server to update the document to include the witness security stamp. In embodiments the instructions further configure the server to stream video and/or audio data of the signee, from the signee device, to the witness device. In embodiments the instructions further configure the server to receive instructions from the witness device to permit generation of the signee security stamp. In embodiments instructions further configure the server to transmit, to the witness device, either: a partial version of the hash; or the entire hash. In embodiments instructions further configure the server to generate, on the server, or receive from the signee device, a locality sensitive hash. In embodiments instructions further configure the server to generate the signee security stamp based on the signee's private key and the hash in combination with either or both of: the locality sensitive hash and the randomness metric. In embodiments wherein the communication module is further configured to communicate with a verification device. In embodiments instructions further configure the server to, receive, from the verification device, second writing, a second hash, and a second security stamp to be verified. In embodiments wherein the instructions further configure the server to compare the second writing, second hash and second security stamp against the first writing, first hash and signee security stamp. In embodiments the instructions further configure the server to, if the first writing and second writing differ, generate a value indicative of the difference. In embodiments the instructions further configure the server to calculate a string similarity metric between the first writing and second writing to generate the value indicative of the difference. In embodiments the instructions further configure the server to transmit, to the verification device, the value indicative of the difference, and/or a string comprising the difference between the first writing and second writing.

The application further discloses, in embodiments, a signee device, for use in digitally signing writing in a legal document, wherein a signee has an associated public/private key pair, the signee device comprising: one or more processors; a communication module, to communicate with a server; memory comprising instructions which when executed by one or more of the processors configure the signee device to: receive, from the server a document processed based on a set of rules to extract writing from the document, for signing, from other document data; generate, on the signee device, or receive, from the server: a hash of the extracted writing; a signee security stamp based on a private key associated with the signee and the hash. In embodiments the instructions further configure the device to update the document to include the signee security stamp. In embodiments the instructions further configure the signee device, to generate, on the signee device, or receive, from the server, a randomness metric indicative of randomness of the writing. In embodiments the instructions further configure the signee device to receive the document including the randomness metric. In embodiments the instructions further configure the signee device to receive the document including the hash value. In embodiments the instructions further configure the signee device to receive authentication credentials of the signee and transmit the authentication credentials to the server. In embodiments the instructions further configure the signee to further receive a second level of authentication details and transmit the second level of authentication details to the server. In embodiments the instructions further configure the signee device to transmit the unsigned document to the server. In embodiments the instructions further configure the signee device to receive the updated document from the server. In embodiments the instructions further configure the signee device to, generate on the signee device, or receive, from the server, a witness security stamp, associated with a witness of the signee signing the document. In embodiments the instructions further configure the signee device to stream video and/or audio data of the signee, to a witness device. In embodiments the instructions further configure the signee device to receive instructions from the witness device which permit generation of the signee security stamp. In embodiments instructions further configure the signee device to generate, on the signee device, or receive from the server device, a locality sensitive hash. In embodiments instructions further configure the signee device to receive the signee security stamp based on the signee's private key and the hash in combination with either or both of: the locality sensitive hash and the randomness metric.

The application further discloses, in embodiments, a witness device, for use in digitally signing writing in a legal document, wherein a signee has an associated public/private key pair, the witness device comprising: one or more processors; a communication module, to communicate with a server; memory comprising instructions which when executed by one or more of the processors configure the witness device to: receive, from the server: a document processed based on a set of rules to extract writing from the document, for signing, from other document data; a hash of the extracted writing; a signee security stamp based on a private key associated with the signee and the hash; and receive, from the server, or generate, on the witness device: a witness security stamp based on a private key associated with a witness and the hash. In embodiments the instructions further configure to witness device to update the document to include the witness security stamp. In embodiments the instructions further configure the witness device to receive video and/or audio stream data of the signee, from the signee device, to the witness device. In embodiments the instructions further configure the witness device to transmit instructions to permit generation of the signee security stamp. In embodiments instructions further configure the witness device to receive, from the server, either: a partial version of the hash; or the entire hash.

The application further discloses, in embodiments, apparatus, for use in digitally signing writing in a legal document, wherein a signee has an associated public/private key pair, the server comprising: one or more processors; memory comprising instructions which when executed by one or more of the processors configure the apparatus to: process a document based on a set of rules to extract writing from the document, for signing, from other document data; and generate: a hash of the extracted writing; a signee security stamp based on a private key associated with the signee and the hash. In embodiments the instructions further configure the server to update the document to include the signee security stamp. In embodiments the instructions further configure the apparatus to generate a randomness metric indicative of randomness of the writing. In embodiments the instructions further configure the server to: calculate the proportion of the extracted writing which is in a lexicon; and generate the randomness metric by comparing the proportion of the extracted writing which is in the lexicon with the entire writing. In embodiments the proportion of the extracted writing is calculated by the number of: bits, bytes, characters, words, paragraphs, or combinations thereof. In embodiments the instructions further configure the apparatus to update the document to including the randomness metric. In embodiments the instructions further configure the apparatus to update the document to include the hash value. In embodiments instructions further configure the apparatus to generate a locality sensitive hash. In embodiments instructions further configure the apparatus to generate the signee security stamp based on the signee's private key and the hash in combination with either or both of: the locality sensitive hash and the randomness metric.

The application further discloses, in embodiments, apparatus for detection of a hash collision attack, apparatus comprising: one or more processors; memory comprising: a lexicon of a language; instructions when executed by one or more of the processors configure the apparatus to: receive writing; calculate the proportion of the writing which is in the lexicon; generate a randomness metric by comparing the proportion of the extracted writing which is in the lexicon; compare the generated randomness metric with a predetermined threshold.

The application further discloses, in embodiments, a method, on a server, for digitally signing writing in a legal document, wherein a signee has an associated public/private key pair, the method comprising: communicating with a signee device; processing a document based on a set of rules to extract writing from the document, for signing, from other document data; and generating, on the server, or receiving, from the signee device: a hash of the extracted writing; a signee security stamp based on a private key associated with the signee and the hash. In embodiments the method further comprises updating the document to include the signee security stamp. In embodiments the method further comprises generating, on the server, or receiving, from the signee device, a randomness metric indicative of randomness of the writing. In embodiments the method further comprises calculating the proportion of the extracted writing which is in a lexicon; and generating the randomness metric by comparing the calculated proportion of the extracted writing which is in the lexicon with the entire writing. In embodiments the method further comprises wherein the proportion of the extracted writing is calculated by the number of: bits, bytes, characters, words, paragraphs, or combinations thereof. In embodiments the method further comprises updating the document to including the randomness metric. In embodiments the method further comprises updating the document to include the hash value. In embodiments the method further comprises authenticating credentials of the signee. In embodiments the method further comprises further authenticating the signee by a second level of authentication. In embodiments the method further comprises receiving the unsigned document from the signee device. In embodiments the method further comprises transmitting the updated document to the signee device. In embodiments the method further comprises communicating with a witness device. In embodiments the method further comprises generating on the server, or receiving, from the signee device or the witness device, a witness security stamp, associated with a witness of the signee signing the document. In embodiments the method further comprises updating the document to include the witness security stamp. In embodiments the method further comprises streaming video and/or audio data of the signee, from the signee device, to the witness device. In embodiments the method further comprises receiving instructions from the witness device to permit generation of the signee security stamp. In embodiments the method further comprises transmitting, to the witness device, either: a partial version of the hash; or the entire hash. In embodiments the method further comprises generating, on the server, or receiving from the signee device, a locality sensitive hash. In embodiments the method further comprises generating the signee security stamp based on the signee's private key and the hash in combination with either or both of: the locality sensitive hash and the randomness metric. In embodiments the method further comprises communicating with a verification device. In embodiments the method further comprises receiving, from the verification device, second writing, a second hash, and a second security stamp to be verified. In embodiments the method further comprises comparing the second writing, second hash and second security stamp against the first writing, first hash and signee security stamp. In embodiments the method further comprises if the first writing and second writing differ, generating a value indicative of the difference. In embodiments the method further comprises calculating a string similarity metric between the first writing and second writing to generate the value indicative of the difference. In embodiments the method further comprises transmitting, to the verification device, the value indicative of the difference, and/or a string comprising the difference between the first writing and second writing.

The application further discloses, in embodiments, a method, on a signee device, for digitally signing writing in a legal document, wherein a signee has an associated public/private key pair, the method comprising: communicating with a server; receiving, from the server a document processed based on a set of rules to extract writing from the document, for signing, from other document data; generating, on the signee device, or receive, from the server: a hash of the extracted writing; a signee security stamp based on a private key associated with the signee and the hash. In embodiments the method further comprises updating the document to include the signee security stamp. In embodiments the method further comprises generating, on the signee device, or receiving, from the server, a randomness metric indicative of randomness of the writing. In embodiments the method further comprises receiving the document including the randomness metric. In embodiments the method further comprises receiving the document including the hash value. In embodiments the method further comprises receiving authentication credentials of the signee and transmitting the authentication credentials to the server. In embodiments the method further comprises further receiving a second level of authentication details and transmitting the second level of authentication details to the server. In embodiments the method further comprises transmitting the unsigned document to the server. In embodiments the method further comprises receiving the updated document from the server. In embodiments the method further comprises generating on the signee device, or receiving, from the server, a witness security stamp, associated with a witness of the signee signing the document. In embodiments the method further comprises streaming video and/or audio data of the signee, to a witness device. In embodiments the method further comprises receiving instructions from the witness device which permit generation of the signee security stamp. In embodiments the method further comprises generating, on the signee device, or receiving from the server device, a locality sensitive hash. In embodiments the method further comprises receiving the signee security stamp based on the signee's private key and the hash in combination with either of both of: the locality sensitive hash and the randomness metric.

The application discloses, in further embodiments, a method, on a witness device, for digitally signing writing in a legal document, wherein a signee has an associated public/private key pair, the method comprising: communicating with a server; receiving, from the server: a document processed based on a set of rules to extract writing from the document, for signing, from other document data; a hash of the extracted writing; signee security stamp based on a private key associated with the signee and the hash; and receiving, from the server, or generating, on the witness device: a witness security stamp based on a private key associated with a witness and the hash. In embodiments the method further comprises updating the document to include the witness security stamp. In embodiments the method further comprises receiving video and/or audio stream data of the signee, from the signee device, to the witness device. In embodiments the method further comprises transmitting instructions to permit generation of the signee security stamp. In embodiments the method further comprises receiving, from the server, either: a partial version of the hash; or the entire hash.

The application discloses, in further embodiments, a method, on an apparatus, for digitally signing writing in a legal document, wherein a signee has an associated public/private key pair, the method comprising: processing a document based on a set of rules to extract writing from the document, for signing, from other document data; and generating: a hash of the extracted writing; a signee security stamp based on a private key associated with the signee and the hash. In embodiments the method further comprises updating the document to include the signee security stamp. In embodiments the method further comprises generating a randomness metric indicative of randomness of the writing. In embodiments the method further comprises: calculating the proportion of the extracted writing which is in a lexicon; and generating the randomness metric by comparing the proportion of the extracted writing which is in the lexicon with the entire writing. In embodiments the method further comprises wherein the proportion of the extracted writing is calculated by the number of: bits, bytes, characters, words, paragraphs, or combinations thereof. In embodiments the method further comprises updating the document to including the randomness metric. In embodiments the method further comprises updating the document to include the hash value. In embodiments the method further comprises generating a locality sensitive hash. In embodiments the method further comprises generating the signee security stamp based on the signee's private key and the hash in combination with either or both of: the locality sensitive hash and the randomness metric.

The application further discloses, in embodiments, a method for detection of a hash collision attack, the method comprising: receiving writing; calculating the proportion of the writing which is in the lexicon; generating a randomness metric by comparing the proportion of the extracted writing which is in a lexicon; comparing the generated randomness metric with a predetermined threshold.

The application further discloses, in embodiments, a computer readable medium comprising instructions which when executed by one or more processors, cause the processor or processors together to provide, on a server, a controller for digitally signing writing in a legal document, wherein a signee has an associated public/private key pair, the controller being configured to: communicate with a signee device; process a document based on a set of rules to extract writing from the document, for signing, from other document data; and generate, on the server, or receive, from the signee device: a hash of the extracted writing; a signee security stamp based on a private key associated with the signee and the hash.

The application further discloses, in embodiments, a computer readable medium comprising instructions which when executed by one or more processors, cause the processor or processors together to provide, on a signee device, a controller for digitally signing writing in a legal document, wherein a signee has an associated public/private key pair, the controller being configured to: communicate with a server; receive, from the server a document processed based on a set of rules to extract writing from the document, for signing, from other document data; generate, on the signee device, or receive, from the server: a hash of the extracted writing; a signee security stamp based on a private key associated with the signee and the hash.

The application further discloses, in embodiments, a computer readable medium comprising instructions which when executed by one or more processors, cause the processor or processors together to provide, on a witness device, a controller for digitally signing writing in a legal document, wherein a signee has an associated public/private key pair, the controller being configured to: communicate with a server; receive, from the server: a document processed based on a set of rules to extract writing from the document, for signing, from other document data; a hash of the extracted writing; a signee security stamp based on a private key associated with the signee and the hash; and receive, from the server, or generate, on the witness device: a witness security stamp based on a private key associated with a witness and the hash.

The application further discloses, in embodiments, a computer readable medium comprising instructions which when executed by one or more processors, cause the processor or processors together to provide, on an apparatus, a controller for digitally signing writing in a legal document, wherein a signee has an associated public/private key pair, the controller being configured to: process a document based on a set of rules to extract writing from the document, for signing, from other document data; and generate: a hash of the extracted writing; a signee security stamp based on a private key associated with the signee and the hash.

The application further discloses, in embodiments, a computer readable medium comprising instructions which when executed by one or more processors, cause the processor or processors together to provide, on an apparatus, a controller for digitally signing writing in a legal document, wherein a signee has an associated public/private key pair, the controller being configured to: receive writing; calculate the proportion of the writing which is in the lexicon; generate a randomness metric by comparing the proportion of the extracted writing which is in a lexicon; compare the generated randomness metric with a predetermined threshold.

### BRIEF DESCRIPTION OF THE DRAWINGS

Embodiments of the invention are further described hereinafter with reference to the accompanying drawings, in which:

FIG. 1 is a diagram of a server.

FIG. 2 is a diagram of a signee device.

FIG. 3 is a diagram of a witness device.

FIG. 4 illustrates a system for digitally signing writing in a legal document.

FIGS. 5A & 5B provides an example of extracting writing from a document.

FIG. 6 is a timing diagram illustrating interaction between a server, signee device and witness device.

FIG. 7 provides a flow diagram of a process for detection of a hash collision attack.

FIG. 8 illustrates an electronically signed legal document.

### DETAILED DESCRIPTION

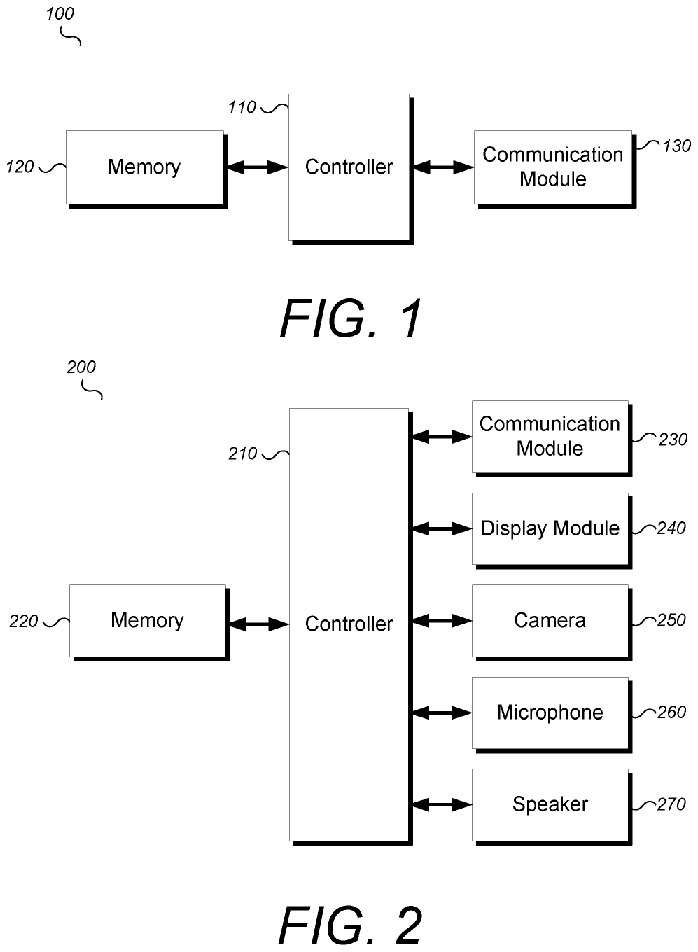

FIG. 1 illustrates a server 100 according to the present embodiments. The server 100 comprises at least a controller 110, a memory 120 and a communication module 130. The controller 110 may be one or more processors and be configured to execute machine readable instructions. The controller 110 is coupled to both the memory 120 and communication module 130.

The memory 120 may be random access memory, and be configured to store instructions to be executed by the controller 110. The communication module 130 may be configured to both receive and transmit data. Further, the communication module 130 may be configured to transmit data over a wired or wireless connection. The wired connection may be configured as an Ethernet connection. Alternatively the wireless connection may be configured in accordance with W-Fi or any other telecommunication standards.

FIG. 2 illustrates a signee device 200 according to the present embodiments. The signee device comprises a controller 210, a memory 220, a communication module 230, a display module 240, a camera 250, a microphone 260 and a speaker 270. The controller 210 may be one or more processors and be configured to execute machine readable instructions. The controller 210 is coupled to the memory 120, the communication module 230, the display module 240, the camera 250, the microphone 260 and the speaker 270.

The memory 220 may be random access memory, and be configured to store instructions to be executed by the controller 210. The communication module 230 may be configured to both receive and transmit data. Further, the communication module 230 may be configured to transmit data over a wired or wireless connection. The wired connection may be configured as an Ethernet connection. Alternatively the wireless connection may be configured in accordance with W-Fi or any other telecommunication standards.

The display module 240 may provide a graphical representation of instruction executed by the controller. The camera 250 may be configured to capture image or video information. The microphone 260 may be configured to record sound information. The speaker may be configured to output sound from the device.

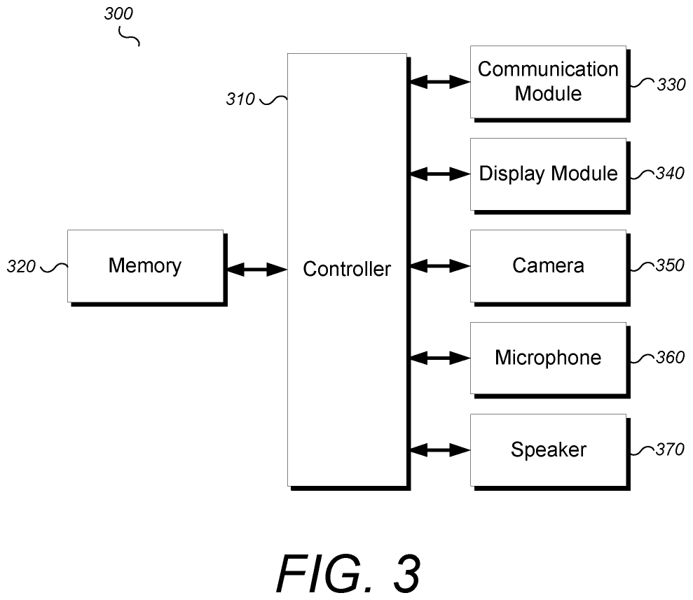

FIG. 3 illustrates a witness device 300 according to the present embodiments. The signee device comprises a controller 310, a memory 320, a communication module 330, a display module 340, a camera 350, a microphone 360 and a speaker 370. The controller 310 may be one or more processors and be configured to execute machine readable instructions. The controller 310 is coupled to the memory 320, the communication module 330, the display module 340, the camera 350, the microphone 360 and the speaker 370.

The memory 320 may be random access memory, and be configured to store instructions to be executed by the controller 310. The communication module 330 may be configured to both receive and transmit data. Further, the communication module 330 may be configured to transmit data over a wired or wireless connection. The wired connection may be configured as an Ethernet connection. Alternatively the wireless connection may be configured in accordance with W-Fi or any other telecommunication standards.

The display module 340 may provide a graphical representation of instruction executed by the controller. The camera 350 may be configured to capture image or video information. The microphone 360 may be configured to record sound information. The speaker may be configured to output sound from the device.

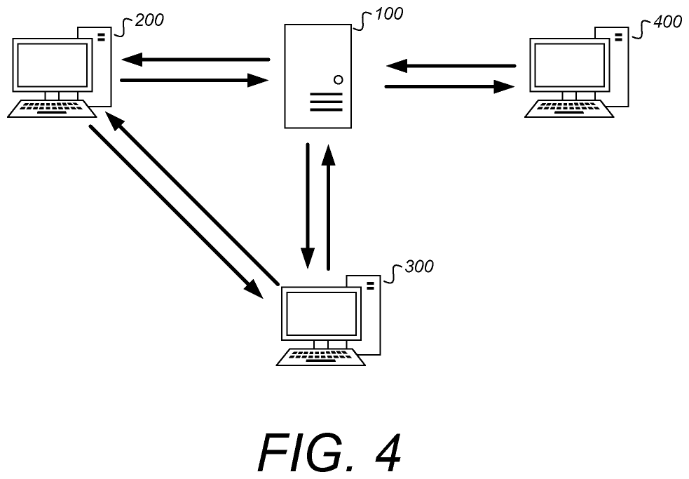

FIG. 4 illustrates the server 100, the signee device 200, the witness device 300 and a verification device 400. The server 100 may communicate data with the signee device 200, the witness device 300 and the verification device 400. Further, the signee device 200 may also communicate data with the witness device 300.

It will be readily understood that the configuration shown in FIG. 4 may not be the only communication configuration between the server 100, signee device 200, witness device 300 and verification device 400. For example, all devices may communicate directly through a single router, or they may communicate via multiple routers. As such, the server 100, signee device 200, witness device 300 and the verification device 400 may not all exist on the same network, and may exist of differing networks which may communicate, for example via the internet. It will also be appreciated that the server 100, signee device 200, witness device 300 and the verification device 400 may not necessarily be distinct physical devices, they may, for example, be virtualised on a single platform, or one device may be provided comprising all the functionality of all the devices.

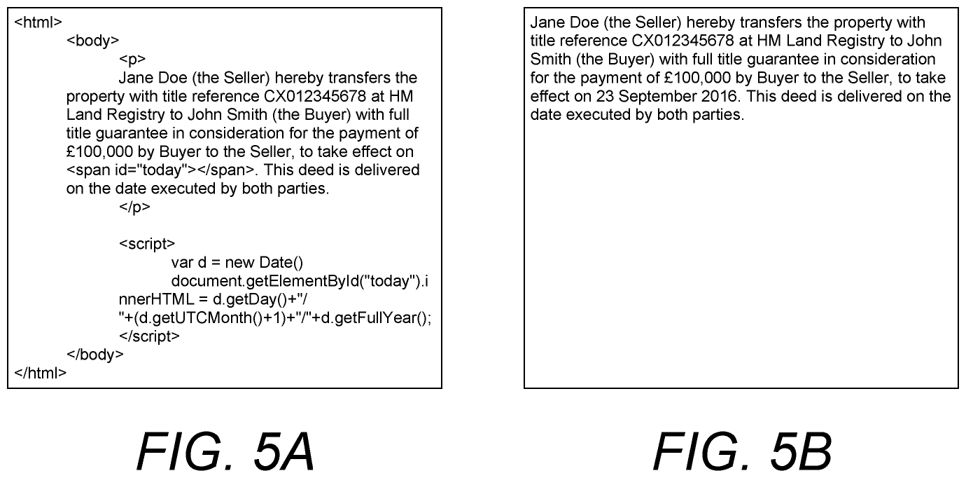

FIGS. 5A & 5B illustrate a method of extracting writing from a document. By way of example, a first person ‘Jane Doe’ wishes to transfer real estate to a second person ‘John Smith’. This achieved using a legal document, in this example, the legal document is a land transfer instrument.

The land transfer instrument in this example is a standard template in the form of a HTML document. This only requires certain inputs, such as the party names, the title reference, and the payment amount, etc. FIG. 5A illustrates the HTML code of a completed land transfer instrument. This code comprises both tags, elements and JavaScript in order to facilitate the rendering of the document. To ensure that the signing party, and others relying on the signed document, can trust that they are signing their consent (or that consent has been given) only to the legible provisions that are apparent from the rendering of the agreement in a given viewer of the file, the processing of the file in an accordance with the claimed subject matter provides that only writing is signed when signing a document, and not the whole contents of the file.

A process of extracting only the writing from an electronic document, in this case the HTML code of FIG. 5A, will now be described in more detail. This process may be carried out at server 100.

Each element of the HTML code is compared to a list of elements stored, for example in memory 120, and may processed in accordance with a set of rules also stored, for example in memory 120. If an element in the code matches that in the stored list, a determination is made as to whether it should be categorised as writing or other data.

For example, it may be determined that only the text string between the “<p>” tag and “</p>” tag should be categorised as writing. This writing may be extracted from the file and stored as a string in a database. It may also determine that a date between the “<span id=“today”>” tag and “</span>” tag that is to be displayed as writing. This span tag references the JavaScript code within the “<script> and </script> tags. This JavaScript code determines the current date is the day/month/year format, which may then be determined to be writing within the “<p>” tag and “</p>” tag. Other elements, such as the tags themselves and other code and metadata, may be characterised, based on the stored list of elements and set of rules, as other data, and may be extracted and stored as a string or strings such in database.

FIG. 5B illustrates the extracted writing. The writing includes the date the writing was extracted.

It will be appreciated the process of extracting writing as described in relation to FIGS. 5A & 5B may be executed by the server 100 or the witness device 200, or both the server 100 and witness device in combination with one another. It will also be appreciated that the process for extracting writing is not limited to HTML documents. For example, Microsoft Word®, OpenOffice®, PDF and XML documents may also be used.

In each case, the processing results in the extraction of certain elements of the file or file output as writing, and other elements as other data. The writing normally corresponds to the elements of the file that are apparent and legible to the viewer of the file when the file is processed and rendered on a display using a suitable viewer executable. This is achieved by the reference to the stored list of elements and set of rules configured for extracting writing from a given type or configuration of file and/or agreement.

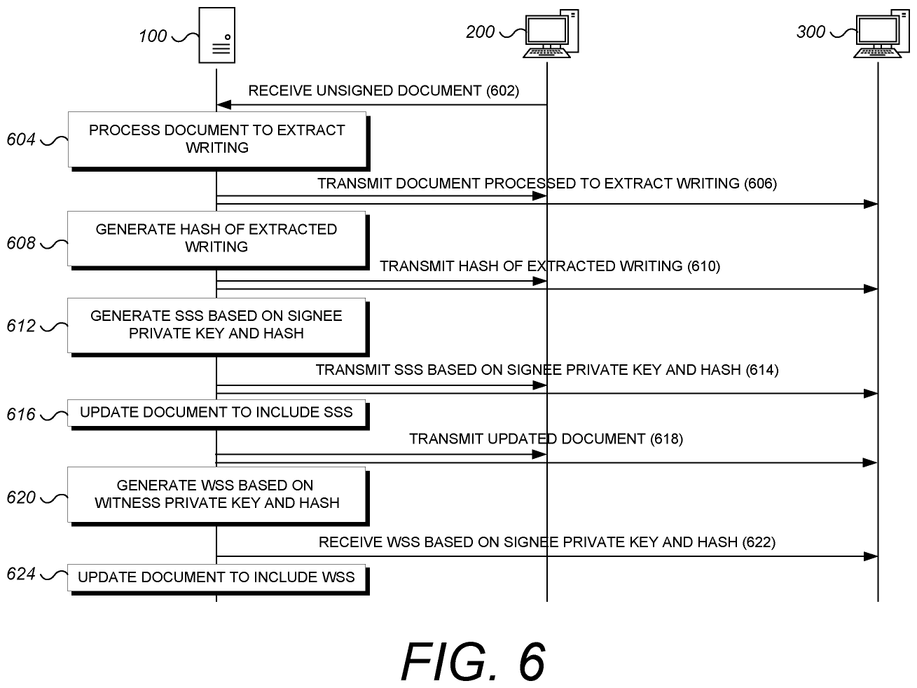

A method of digitally signing a document will now be described in relation to FIG. 6. As a precursor to the method shown in FIG. 6, the user of a signee device 200 may point a suitable browser of said device to a URL providing a document signing web service served by server 100 or a related server. The user may log in to a user account supported thereby using suitable credentials.

At 602, the server 100 may receive an unsigned document from a signee device 200. A user operating the signee 200 may have manually produced the unsigned document using, for example, word processing software. Alternatively, the user may obtain the document from another source, for example, the internet. The obtained document may be a complete document, or it may be uncompleted, and completed on the signee device. Tye user of the signee device 200 may have uploaded the file to the server via the browser.

At 604 the server 100 may process the document to extract the writing. The document may be processed in accordance with a set of rule. For example, the raw document may include code for the purposes of rendering the document. This code is not viewable when the document is rendered and therefore it may be disregarded when extracting the writing from document. The process used to extract the writing from the document may be similar to that described in relation to FIGS. 5A & 5B. The extracted writing may then be stored on the server 100.

At 606, the extracted writing may be transmitted from the server 100 to the signee device 200 and may be transmitted to the witness device 300.

At 608, the server 100 may generate a hash of the extracted writing. The hash may be generated using a hashing algorithm. Further, additional data be added when generating the hash, resulting in a ‘salted’ hash.

At 610, the hash may be transmitted from the server 100 to the signee device 200 and may also be transmitted to the witness device 300.

Here, the signee and the witness devices may be operated, as will be explained below, by the signee and witness users thereof, to give effect to the signing of the documents, or more specifically the writing extracted therefrom, using for example the web service, by using suitable electronic means to give their assent thereto.

A user of the signee device 200, the signee, may have an associated public/private key pair. The private key may only be known to the signee, whereas the public key may publically known. The public key may be used to verify files generated using the private key.

At 612, the server 100 may generate a signee security stamp. The signee security stamp may be based on a combination of the signee's private key and the generated hash.

The signing/witnessing of the document by the application thereto of the signee/witness security stamp may be effected by the signee and witness users of the signee and witness devices instructing the server 100, having securely signed in to the web service provided thereby using suitable credentials, to apply said stamp to the document using that user's private key, which may be securely held by the server 100. Alternatively, the signee or witness may carry a smart card which securely holds the user's private key, and the signee and witness may give effect to the application of the signee and witness security stamp respectively locally at the signee and witness devices using the smart cards held in their possession. The user may be required to input a security code or other security mechanisms may be used to give effect to the application of the appropriate security stamp. In the example shown in FIG. 6, the server 100 generates the signee and witness security stamps.

At 614, the signee security stamp may be transmitted from the server 100 to the signee device 200 and may also be transmitted to the witness device 300.

At 616, the unsigned document may be updated to include the generated signee security stamp. The signee security stamp may be include in the document represented as a hexadecimal text string, or any other means or representing the stamp, such as QR code.

At step 618, the updated document may be transmitted from the server 100 to the signee device 200 and may also be transmitted to the witness device 300.

The signing of legal documents sometimes are required to be witnessed by a third party. This in turn requires a signature on the document by the witness. It will now be described how witness may digitally sign a legal document.

A user of the witness device 300, the witness, may have an associated public/private key pair. The private key may only be known to the witness, whereas the public key may publically known. The public key may be used to verify files generated using the private key.

At 620, the server 100 may generate a witness security stamp. The witness security stamp may be based on a combination of the signee's private key and the generated hash.

At 622, the witness security stamp may be transmitted from the server 100 to the signee device 200 and may also be transmitted to the witness device 300.

At 624, the unsigned document may be updated to include the generated witness security stamp. The signee security stamp may be include in the document represented as a hexadecimal text string, or any other means or representing the stamp, such as QR code.

It will be appreciated that the transmission of the extracted writing, the hash, the signee security stamp, the updated document and the witness security stamp may not necessarily be transmitted to the signee device 200 or witness device 300. For example, only the updated document may be transmitted. Alternatively, the updated document, the extracted writing, the hash, and the witness security stamp may all be sent at once, or in different combinations with one another.

In some embodiments, the following additional and optional steps may also be performed. The server 100, may generate a randomness metric indicative of the randomness of the writing. The randomness metric may also be used to generate the signee security stamp and/or the witness security stamp. Further, the document may be updated to include the randomness metric and/or the hash. The server 100 may also generate a locality sensitive hash base on the writing. The locality sensitive hash may also be used to generate the signee/witness security stamp.

The functionality of the witness device 300 will now be described in more detail. If a witness is physically in the same place as the signee, in one embodiment, the witness may manually record the hash of the file. The witness may write this down for example. Alternatively, the signee device may display a partial version of the hash. The signee device may further prompt the signee to enter contact details of the witness, for example, an email address. The witness may then be contacted to witness the document on the witness device 300.

On the witness device 300, the witness may be prompted to enter the hash or partial version of the hash corresponding to the document they witness being signed by the signee. If the correct hash or partial hash is entered, it may be verified that the witness is signing the same writing as that of the signee.

The facilitation of a witness device also allows for a remote-witness, i.e. a witness not physically in the same place as the user. In this situation, the witness may witness the signee signing the document over a live audio/video transmission and then add their own witness security stamp. Alternatively, the witness may be able to prevent the signee signing the document until they are satisfied with the signee. For example, verifying their identity and checking they are not under duress.

In a further embodiment, as part of the signing process, the signee security stamp and the witness security stamp may be added to a block chain. A third part would therefore be in a position to independently verify that a legal document has been signed by inspecting the block chain.

The verification device 400 may be used to verify the authenticity of a security stamp. A verifier may input a signed document onto a verification device. The verification device may then extract writing, and generate a hash and security stamp to be verified. These may then be compared with the original signed document on the server 100. The server may then generate a value indicative of the difference between the original writing and the second writing. Further, if a locality sensitive hash has been used, a value indicative of the difference between the hashes may be used. This may allow a verifier to judge how close a document to be verified is against an original.

Further, it will be appreciated that the aforementioned steps may not all be performed on the server, but may be performed by the signee device 200, or another third party device. For example, the writing may be extracted on the signee device 200 and then transmitted to the server 100.

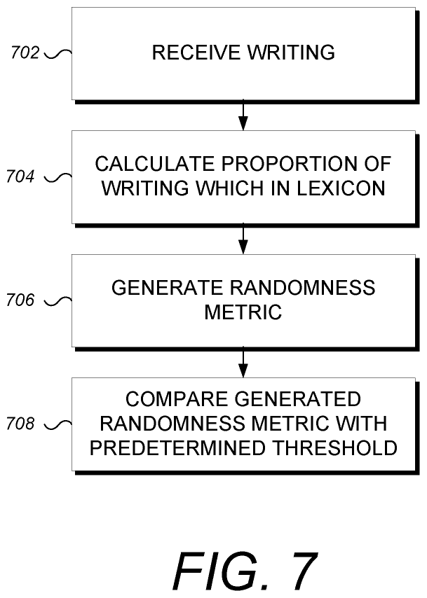

A process of generating a randomness metric will now be described in relation to FIG. 7. A randomness metric may be used to detect a hash collision attack. By mathematical definition, there exists the possibility of two different files generating the same hash. Although it is unlikely that two similar document will generate an identical hash, it may be important to identify when a hash collision attack has been attempted. It is further even more unlikely that a file which generated the same hash as that of extracted writing of a legal document would also consist of readable writing. It is much more likely to be a random assortment of characters.

As an example, if you have a message “Rob owes Dave £100” with cryptographic security stamp “123456” signed by Rob, and you want to use a collision attack to fraudulently claim that Rob in fact signed a message that says “Rob owes Dave £1000” in theory you could do this by adding random numbers to the message, and cycling through them until you get a cryptographic security stamp the same as the original message—e.g. “Rob owes Dave £10,000 bGvkwl449nc29linu”. To detect and avoid an attempted collision attack, reference to a Lexicon is used to determine a randomness metric. In this approach, the first message has 12 characters in 19 which are in a Lexicon. The second message has 12 characters in 39 which are in the same Lexicon. Wherever a document has the same cryptographic security stamps or hashes, but the randomness metric does not agree, it is likely that a collision attack has been attempted. Referring now to FIG. 7, at 702, a device, for example a server 100, a signee device 200 or a witness device 300 receives writing. The writing may be in the form of text string. At 704, the device may then compare the received writing with that of writing which appears in a lexicon. If the writing to be compared is intended to be in the English language, the lexicon may comprise a list of words used in the English language.

At 706, the randomness metric is generated by evaluating the proportion of writing which appears in the lexicon.

At 708, the generated randomness metric may be compared with that of a predetermined threshold. If the randomness metric is above the threshold, it may be judged that it is actually writing. If the randomness metric is below the threshold, it may be judged that it is not writing, and includes a high amount of what appears to be random data.

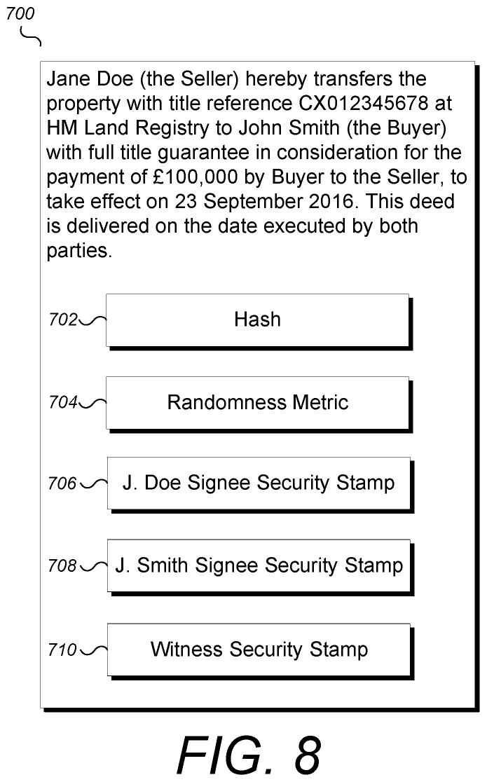

FIG. 8 illustrates an electronically signed legal document. The document 700 includes writing, and the document has been updated to include a hash 702 of the extracted writing and a randomness metric 704. Further, a private key of a first signee, J. Doe is used to generate a first signee security stamp 706. Also, a private key of a second signee, J. Smith is used to generate a second signee security stamp. Finally, a private key of a witness is used to generate a witness security stamp.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics, described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A server, for use in digitally signing writing in a legal document, wherein a signee has an associated public/private key pair, the server comprising:
one or more processors;
a communication module, to communicate with a signee device;
memory comprising instructions which when executed by one or more of the processors configure the server to:
process a document based on a set of rules to extract writing from the document, for signing, from other document data; and
generate, on the server, or receive, from the signee device:
a hash of the extracted writing;
a signee security stamp based on a private key associated with the signee and the hash.

2. A server as claimed in claim 1, wherein the instructions further configure the server to update the document to include the signee security stamp.

3. A server as claimed in claim 1 or 2, wherein the instructions further configure the server to generate, on the server, or receive, from the signee device, a randomness metric indicative of randomness of the writing.

4. A server as claimed in claim 3, wherein the instructions further configure the server to:
calculate the proportion of the extracted writing which is in a lexicon; and
generate the randomness metric by comparing the proportion of the extracted writing which is in the lexicon with the entire writing.

5. A server as claimed in claim 4, wherein the proportion of the extracted writing is calculated by the number of: bits, bytes, characters, words, paragraphs, or combinations thereof.

6. A server as claimed in claim 3, 4 or 5, wherein the instructions further configure the server to update the document to including the randomness metric.

7. A server as claimed in any preceding claim, wherein the instructions further configure the server to update the document to include the hash value.

8. A server as claimed in any preceding claim, wherein the instructions further configure the server to authenticate credentials of the signee, and/or to create a session with session variables uniquely linked to the web browser used by the signee.

9. A server as claimed in claim 8, wherein the instructions further configure the server to further authenticate the signee by a second level of authentication, and/or to verify that the signee's web browser is being operated by an individual with access to information and/or hardware which should only be in the possession of the signee.

10. A server as claimed in any preceding claim, wherein the instructions further configure the server to receive the unsigned document from the signee device.

11. A server as claimed in any of claims 2 to 10, wherein the instructions further configure the server to transmit the updated document to the signee device.

12. A server as claimed in any preceding claim, wherein the communication module is further configured to communicate with a witness device.

13. A server as claimed in claim 12, wherein the instructions further configure the server to, generate on the server, or receive, from the signee device or the witness device, a witness security stamp, associated with a witness of the signee signing the document.

14. A server as claimed in claim 13, wherein the instructions further configure the server to update the document to include the witness security stamp.

15. A server as claimed in claim 12, 13 or 14, wherein the instructions further configure the server to stream video and/or audio data of the signee, from the signee device, to the witness device.

16. A server as claimed in claim 13, 14 or 15, wherein the instructions further configure the server to receive instructions from the witness device to permit generation of the signee security stamp.

17. A server as claimed in any of claims 13 to 16, wherein instructions further configure the server to transmit, to the witness device, either:
a partial version of the hash; or
the entire hash.

18. A server as claimed in any preceding claim, wherein instructions further configure the server to generate, on the server, or receive from the signee device, a locality sensitive hash.

19. A server as claimed in claim 18, wherein instructions further configure the server to generate the signee security stamp based on the signee's private key and the hash in combination with either or both of: the locality sensitive hash and the randomness metric.

20. A server as claimed in any preceding claim, wherein the communication module is further configured to communicate with a verification device.

21. A server as claimed in claim 20, wherein instructions further configure the server to, receive, from the verification device, second writing, a second hash, and a second security stamp to be verified.

22. A server as claimed in claim 21, wherein the instructions further configure the server to compare the second writing, second hash and second security stamp against the first writing, first hash and signee security stamp.

23. A server as claimed in claim 22, wherein the instructions further configure the server to, if the first writing and second writing differ, generate a value indicative of the difference.

24. A server as claimed in claim 23, wherein the instructions further configure the server to calculate a string similarity metric between the first writing and second writing to generate the value indicative of the difference.

25. A server as claimed in claim 23 or 24, wherein the instructions further configure the server to transmit, to the verification device, the value indicative of the difference, and/or a string comprising the difference between the first writing and second writing.

26. A signee device, for use in digitally signing writing in a legal document, wherein a signee has an associated public/private key pair, the signee device comprising:
one or more processors;
a communication module, to communicate with a server;
memory comprising instructions which when executed by one or more of the processors configure the signee device to:
receive, from the server a document processed based on a set of rules to extract writing from the document, for signing, from other document data;
generate, on the signee device, or receive, from the server:
a hash of the extracted writing;
a signee security stamp based on a private key associated with the signee and the hash.

27. A signee device as claimed in claim 26, wherein the instructions further configure the device to update the document to include the signee security stamp.

28. A signee device as claimed in claim 26 or 27, wherein the instructions further configure the signee device, to generate, on the signee device, or receive, from the server, a randomness metric indicative of randomness of the writing.

29. A signee device as claimed in claim 28, wherein the instructions further configure the signee device to receive the document including the randomness metric.

30. A signee device as claimed in any of claims 26 to 29, wherein the instructions further configure the signee device to receive the document including the hash value.

31. A signee device as claimed in any of claims 26 to 30, wherein the instructions further configure the signee device to receive authentication credentials of the signee and transmit the authentication credentials to the server.

32. A signee device as claimed in any of claims 26 to 31, wherein the instructions further configure the signee to further receive a second level of authentication details and transmit the second level of authentication details to the server.

33. A signee device as claimed in any of claims 26 to 32, wherein the instructions further configure the signee device to transmit the unsigned document to the server.

34. A signee device as claimed in any of claims 27 to 33, wherein the instructions further configure the signee device to receive the updated document from the server.

35. A signee device as claimed in any of claims 26 to 34, wherein the instructions further configure the signee device to, generate on the signee device, or receive, from the server, a witness security stamp, associated with a witness of the signee signing the document.

36. A signee device as claimed in any of claims 26 to 35, wherein the instructions further configure the signee device to stream video and/or audio data of the signee, to a witness device.

37. A signee device as claimed in claim 36, wherein the instructions further configure the signee device to receive instructions from the witness device which permit generation of the signee security stamp.

38. A signee device as claimed in any of claims 26 to 37, wherein instructions further configure the signee device to generate, on the signee device, or receive from the server device, a locality sensitive hash.

39. A signee device as claimed in claim 38, wherein instructions further configure the signee device to receive the signee security stamp based on the signee's private key and the hash in combination with either or both of: the locality sensitive hash and the randomness metric.

40. A witness device, for use in digitally signing writing in a legal document, wherein a signee has an associated public/private key pair, the witness device comprising:
one or more processors;
a communication module, to communicate with a server;
memory comprising instructions which when executed by one or more of the processors configure the witness device to:
receive, from the server:
a document processed based on a set of rules to extract writing from the document, for signing, from other document data;
a hash of the extracted writing;
a signee security stamp based on a private key associated with the signee and the hash; and
receive, from the server, or generate, on the witness device:
a witness security stamp based on a private key associated with a witness and the hash.

41. A witness device as claimed in claim 40, wherein the instructions further configure to witness device to update the document to include the witness security stamp.

42. A witness device as claimed in claim 40 or 41, wherein the instructions further configure the witness device to receive video and/or audio stream data of the signee, from the signee device, to the witness device.

43. A witness device as claimed in claim 40, 41 or 42, wherein the instructions further configure the witness device to transmit instructions to permit generation of the signee security stamp.

44. A witness device as claimed in any of claims 40 to 43, wherein instructions further configure the witness device to receive, from the server, either:
a partial version of the hash; or
the entire hash.

45. Apparatus, for use in digitally signing writing in a legal document, wherein a signee has an associated public/private key pair, the server comprising:
one or more processors;
memory comprising instructions which when executed by one or more of the processors configure the apparatus to:
process a document based on a set of rules to extract writing from the document, for signing, from other document data; and
generate:
a hash of the extracted writing;
a signee security stamp based on a private key associated with the signee and the hash.

46. Apparatus as claimed in claim 45, wherein the instructions further configure the server to update the document to include the signee security stamp.

47. Apparatus as claimed in claim 45 or 46, wherein the instructions further configure the apparatus to generate a randomness metric indicative of randomness of the writing.

48. Apparatus as claimed in claim 47, wherein the instructions further configure the server to:
calculate the proportion of the extracted writing which is in a lexicon; and
generate the randomness metric by comparing the proportion of the extracted writing which is in the lexicon with the entire writing.

49. Apparatus as claimed in claim 48, wherein the proportion of the extracted writing is calculated by the number of: bits, bytes, characters, words, paragraphs, or combinations thereof.

50. Apparatus as claimed in any of claim 47, 48 or 49, wherein the instructions further configure the apparatus to update the document to including the randomness metric.

51. Apparatus as claimed in any of claims 45 to 50, wherein the instructions further configure the apparatus to update the document to include the hash value.

52. Apparatus as claimed in any of claims 45 to 51, wherein instructions further configure the apparatus to generate a locality sensitive hash.

53. Apparatus as claimed in claim 52, wherein instructions further configure the apparatus to generate the signee security stamp based on the signee's private key and the hash in combination with either or both of: the locality sensitive hash and the randomness metric.

54. Apparatus for detection of a hash collision attack, apparatus comprising:
one or more processors;
memory comprising:
a lexicon of a language;
instructions when executed by one or more of the processors configure the apparatus to:
receive writing;
calculate the proportion of the writing which is in the lexicon;
generate a randomness metric by comparing the proportion of the extracted writing which is in the lexicon;
compare the generated randomness metric with a predetermined threshold.

55. A method, on a server, for digitally signing writing in a legal document, wherein a signee has an associated public/private key pair, the method comprising:
communicating with a signee device;
processing a document based on a set of rules to extract writing from the document, for signing, from other document data; and
generating, on the server, or receiving, from the signee device:
a hash of the extracted writing;
a signee security stamp based on a private key associated with the signee and the hash.

56. A method as claimed in claim 55, further comprising updating the document to include the signee security stamp.

57. A method as claimed in claim 55 or 56, further comprising generating, on the server, or receiving, from the signee device, a randomness metric indicative of randomness of the writing.

58. A method as claimed in claim 57, further comprising:
calculating the proportion of the extracted writing which is in a lexicon; and
generating the randomness metric by comparing the calculated proportion of the extracted writing which is in the lexicon with the entire writing.

59. A method as claimed in claim 58, wherein the proportion of the extracted writing is calculated by the number of: bits, bytes, characters, words, paragraphs, or combinations thereof.

60. A method as claimed in claim 57, 58 or 59, further comprising updating the document to including the randomness metric.

61. A method as claimed in any of claims 55 to 60, further comprising updating the document to include the hash value.

62. A method as claimed in any of claims 55 to 61, further comprising authenticating credentials of the signee.

63. A method as claimed in claim 62, further comprising further authenticating the signee by a second level of authentication.

64. A method as claimed in any of claims 55 to 63, further comprising receiving the unsigned document from the signee device.

65. A method as claimed in any of claims 56 to 64, further comprising transmitting the updated document to the signee device.

66. A method as claimed in any of claims 55 to 65, further comprising communicating with a witness device.

67. A method as claimed in claim 66, further comprising, generating on the server, or receiving, from the signee device or the witness device, a witness security stamp, associated with a witness of the signee signing the document.

68. A method as claimed in claim 67, further comprising updating the document to include the witness security stamp.

69. A method as claimed in claim 66, 67 or 68, further comprising streaming video and/or audio data of the signee, from the signee device, to the witness device.

70. A method as claimed in claim 67, 68 or 69, further comprising receiving instructions from the witness device to permit generation of the signee security stamp.

71. A method as claimed in any of claims 66 to 70, further comprising transmitting, to the witness device, either:
a partial version of the hash; or
the entire hash.

72. A method as claimed in any of claims 55 to 71, further comprising generating, on the server, or receiving from the signee device, a locality sensitive hash.

73. A method as claimed in claim 72, further comprising generating the signee security stamp based on the signee's private key and the hash in combination with either or both of: the locality sensitive hash and the randomness metric.

74. A method as claimed in any of claims 55 to 73, further comprising communicating with a verification device.

75. A method as claimed in claim 74, further comprising, receiving, from the verification device, second writing, a second hash, and a second security stamp to be verified.

76. A method as claimed in claim 75, further comprising comparing the second writing, second hash and second security stamp against the first writing, first hash and signee security stamp.

77. A method as claimed in claim 76, further comprising, if the first writing and second writing differ, generating a value indicative of the difference.

78. A method as claimed in claim 77, further comprising calculating a string similarity metric between the first writing and second writing to generate the value indicative of the difference.

79. A method as claimed in claim 76, 77 or 78, further comprising transmitting, to the verification device, the value indicative of the difference, and/or a string comprising the difference between the first writing and second writing.

80. A method, on a signee device, for digitally signing writing in a legal document, wherein a signee has an associated public/private key pair, the method comprising:
communicating with a server;
receiving, from the server a document processed based on a set of rules to extract writing from the document, for signing, from other document data;
generating, on the signee device, or receive, from the server:
a hash of the extracted writing;
a signee security stamp based on a private key associated with the signee and the hash.

81. A method as claimed in claim 80, further comprising updating the document to include the signee security stamp.

82. A method as claimed in claim 80 or 81, further comprising, generating, on the signee device, or receiving, from the server, a randomness metric indicative of randomness of the writing.

83. A method as claimed in claim 82, further comprising receiving the document including the randomness metric.

84. A method as claimed in any of claims 80 to 83, further comprising receiving the document including the hash value.

85. A method as claimed in any of claims 80 to 84, further comprising receiving authentication credentials of the signee and transmitting the authentication credentials to the server.

86. A method as claimed in any of claims 80 to 85, further comprising further receiving a second level of authentication details and transmitting the second level of authentication details to the server.

87. A method as claimed in any of claims 80 to 86, further comprising transmitting the unsigned document to the server.

88. A method as claimed in any of claims 81 to 87, further comprising receiving the updated document from the server.

89. A method as claimed in any of claims 80 to 88, further comprising, generating on the signee device, or receiving, from the server, a witness security stamp, associated with a witness of the signee signing the document.

90. A method as claimed in any of claims 80 to 89, further comprising streaming video and/or audio data of the signee, to a witness device.

91. A method as claimed in any of claims 80 to 90, further comprising receiving instructions from the witness device which permit generation of the signee security stamp.

92. A method as claimed in any of claims 80 to 91, further comprising generating, on the signee device, or receiving from the server device, a locality sensitive hash.

93. A method as claimed in claim 92, further comprising receiving the signee security stamp based on the signee's private key and the hash in combination with either of both of: the locality sensitive hash and the randomness metric.

94. A method, on a witness device, for digitally signing writing in a legal document, wherein a signee has an associated public/private key pair, the method comprising:
communicating with a server;
receiving, from the server:
a document processed based on a set of rules to extract writing from the document, for signing, from other document data;
a hash of the extracted writing;
a signee security stamp based on a private key associated with the signee and the hash; and
receiving, from the server, or generating, on the witness device:
a witness security stamp based on a private key associated with a witness and the hash.

95. A method as claimed in claim 94, further comprising updating the document to include the witness security stamp.

96. A method as claimed in claim 94 or 95, further comprising receiving video and/or audio stream data of the signee, from the signee device, to the witness device.

97. A method as claimed in claim 94, 95 or 96, further comprising transmitting instructions to permit generation of the signee security stamp.

98. A method as claimed in any of claims 94 to 96, wherein further comprising receiving, from the server, either:
a partial version of the hash; or
the entire hash.

99. A method, on an apparatus, for digitally signing writing in a legal document, wherein a signee has an associated public/private key pair, the method comprising:
processing a document based on a set of rules to extract writing from the document, for signing, from other document data; and
generating:
a hash of the extracted writing;
a signee security stamp based on a private key associated with the signee and the hash.

100. A method as claimed in claim 99, further comprising updating the document to include the signee security stamp.

101. A method as claimed in claim 99 or 100, further comprising generating a randomness metric indicative of randomness of the writing.

102. A method as claimed in claim 101, further comprising:
calculating the proportion of the extracted writing which is in a lexicon; and
generating the randomness metric by comparing the proportion of the extracted writing which is in the lexicon with the entire writing.

103. A method as claimed in claim 102, wherein the proportion of the extracted writing is calculated by the number of: bits, bytes, characters, words, paragraphs, or combinations thereof.

104. A method as claimed in any of claim 101, 102 or 103, further comprising updating the document to including the randomness metric.

105. A method as claimed in any of claims 99 to 104, further comprising updating the document to include the hash value.

106. A method as claimed in any of claims 99 to 105, further comprising generating a locality sensitive hash.

107. A method as claimed in claim 106, further comprising generating the signee security stamp based on the signee's private key and the hash in combination with either or both of: the locality sensitive hash and the randomness metric.

108. A method for detection of a hash collision attack, the method comprising:
receiving writing;
calculating the proportion of the writing which is in the lexicon;
generating a randomness metric by comparing the proportion of the extracted writing which is in a lexicon;
comparing the generated randomness metric with a predetermined threshold.

109. Computer readable medium comprising instructions which when executed by one or more processors, cause the processor or processors together to provide, on a server, a controller for digitally signing writing in a legal document, wherein a signee has an associated public/private key pair, the controller being configured to:
communicate with a signee device;
process a document based on a set of rules to extract writing from the document, for signing, from other document data; and
generate, on the server, or receive, from the signee device:
a hash of the extracted writing;
a signee security stamp based on a private key associated with the signee and the hash.

110. Computer readable medium comprising instructions which when executed by one or more processors, cause the processor or processors together to provide, on a signee device, a controller for digitally signing writing in a legal document, wherein a signee has an associated public/private key pair, the controller being configured to:
communicate with a server;
receive, from the server a document processed based on a set of rules to extract writing from the document, for signing, from other document data;
generate, on the signee device, or receive, from the server:
a hash of the extracted writing;
a signee security stamp based on a private key associated with the signee and the hash

111. Computer readable medium comprising instructions which when executed by one or more processors, cause the processor or processors together to provide, on a witness device, a controller for digitally signing writing in a legal document, wherein a signee has an associated public/private key pair, the controller being configured to:
communicate with a server;
receive, from the server:
a document processed based on a set of rules to extract writing from the document, for signing, from other document data;
a hash of the extracted writing;
a signee security stamp based on a private key associated with the signee and the hash; and
receive, from the server, or generate, on the witness device:
a witness security stamp based on a private key associated with a witness and the hash.

112. Computer readable medium comprising instructions which when executed by one or more processors, cause the processor or processors together to provide, on an apparatus, a controller for digitally signing writing in a legal document, wherein a signee has an associated public/private key pair, the controller being configured to:
process a document based on a set of rules to extract writing from the document, for signing, from other document data; and
generate:
a hash of the extracted writing;
a signee security stamp based on a private key associated with the signee and the hash.

113. Computer readable medium comprising instructions which when executed by one or more processors, cause the processor or processors together to provide, on an apparatus, a controller for digitally signing writing in a legal document, wherein a signee has an associated public/private key pair, the controller being configured to:
receive writing;
calculate the proportion of the writing which is in the lexicon;
generate a randomness metric by comparing the proportion of the extracted writing which is in a lexicon;
compare the generated randomness metric with a predetermined threshold.
